(19) United States
(12) Patent Application Publication
(10) Pub. No.: US 2026/0195287 A1
(43) Pub. Date: Jul. 9, 2026

(54) ADDRESSABLE SERIAL PERIPHERAL INTERFACE

(71) Applicant: Renesas Electronics Corporation, Tokyo (JP)

(72) Inventor: Anand GOPALAN, Plano, TX (US)

(73) Assignee: Renesas Electronics Corporation, Tokyo (JP)

(21) Appl. No.: 19/009,362

(22) Filed: Jan. 3, 2025

(51) Int. Cl. G06F 13/42

(52) U.S. Cl. CPC G06F 13/4282; G06F 2213/0002

(57) ABSTRACT

Systems and methods for implementing addressable SPI are described. The system includes a controller and a plurality of devices. The controller includes a SPI bus and a node address (NAD) line. The controller is configured to transmit a chip select signal and a clock signal via the SPI bus, and receive a respective node address signal via the NAD line. The plurality of devices is connected to the SPI bus of the controller. A respective device of the plurality of devices is configured to receive the chip select signal and the clock signal from the controller via the SPI bus; determines a respective node address associated with the respective device based on the chip select signal and the clock signal; generate a respective node address signal indicating the respective node address; and transmit the respective node address signal to an adjacent device in the chain or the NAD line.

### BACKGROUND

The present disclosure relates in general to communication systems and interfaces, particularly, to the implementation of addressable serial peripheral interface (SPI).

Modern applications, such as power net fuse boxes, require rapid data acquisition and diagnostics across multiple loads. These systems often need to poll data from 20-25 devices within a 100-microsecond cycle time to enable load balancing and meet stringent Automotive Safety Integrity Level (ASIL) requirements. Traditional analog feedback systems using hardware multiplexing and buffering struggle to meet these performance demands. Conventional SPI architectures need separate chip select lines for every device, which increases the complexity on the controller side, in terms of increased output ports and their management through software. Daisy-chain SPI architectures face challenges related to speed, reliability, low power operation as well as custom frame lengths. Additionally, both solutions struggle with synchronous control for paralleling multiple devices and functional safety requirements in safety-critical applications.

### SUMMARY

In an aspect, a system for implementing addressable SPI is generally described. The system can include a controller and a plurality of devices. The controller can include an SPI bus and a node address (NAD) line. The controller is configured to transmit a chip select signal and a clock signal via the SPI bus, and receive a respective node address signal via the NAD line. The plurality of devices is connected in a chain. The plurality of devices is connected to the SPI bus of the controller. A respective device of the plurality of devices is configured to receive the chip select signal and the clock signal from the controller via the SPI bus; determines a respective node address associated with the respective device based on the chip select signal and the clock signal; generate a respective node address signal indicating the respective node address; and transmit the respective node address signal to an adjacent device in the chain or the NAD line.

In an aspect, an integrated circuit for implementing addressable SPI is generally described. The system can include a plurality of devices. The plurality of devices is connected to the SPI bus of the controller. A respective device of the plurality of devices is configured to receive a chip select signal and a clock signal from a controller via the SPI bus; determines a respective node address associated with the respective device based on the chip select signal and the clock signal; generate a respective node address signal indicating the respective node address; and transmit the respective node address signal to one of an adjacent device in the chain and a node address (NAD) line of the controller.

In an aspect, a method for managing an addressable SPI system is generally described. The method can include transmitting, by a controller in the SPI system, a global broadcast command and a clock signal to a plurality of devices in the SPI system via a SPI bus. The method can further include receiving, by the controller, a node address signal via a node address line. The method can further include determining a number of devices in the plurality of devices based on the node address signal.

Further features as well as the structure and operation of various embodiments are described in detail below with reference to the accompanying drawings. In the drawings, like reference numbers indicate identical or functionally similar elements.

### BRIEF DESCRIPTION OF THE DRAWINGS

FIG. 1 is a diagram illustrating an example system for implementing an addressable SPI according to an illustrative embodiment.

FIG. 2 illustrates timing diagrams showing the operation of the system 100 for implementing an addressable SPI according to an illustrative embodiment.

FIG. 3 is a diagram showing example frames that implement addressable SPI according to an illustrative embodiment.

FIG. 4 is a diagram illustrating an example device 400 for implementing an addressable SPI system according to an illustrative embodiment.

FIG. 5 is a diagram showing example frames that implement addressable SPI according to an illustrative embodiment.

FIG. 6 illustrate a process for managing an addressable serial peripheral interface (SPI) system according to an illustrative embodiment.

### DETAILED DESCRIPTION

In the following description, numerous specific details are set forth, such as particular

structures, components, materials, dimensions, processing steps and techniques, in order to provide an understanding of the various embodiments of the present application. However, it will be appreciated by one of ordinary skill in the art that the various embodiments of the present application may be practiced without these specific details. In other instances, conventional structures or processing steps have not been described in detail in order to avoid obscuring the present application.

SPI is a widely adopted standard for high-speed communication between a controller (master) and multiple peripheral devices (slaves). In implementations, SPI can operate with four signals, i.e., Clock (SCK) signal which synchronizes data transfer, Chip Select (CS) signal which activates a specific device for communication, Master Out Slave In (MOSI) signal which transfers data from the master to the slave, Master In Slave Out (MISO) signal, which transfers data from the slave back to the master.

In a conventional SPI configuration, each peripheral device requires a dedicated Chip Select line. For instance, a system with four devices would have common Clock, MOSI, and MISO lines, but each device would require a separate Chip Select signal (e.g., CS1, CS2, CS3, and CS4). When the Chip Select signal for a specific device is asserted (e.g., high or low), that device becomes active and can communicate by shifting data in and out based on the Clock signal. While effective, such a conventional architecture becomes impractical as the number of devices increases, as it requires a proportional increase in the controller's input/output (IO) resources.

In a daisy-chain SPI configuration, the output of one device connects to the input of the next device in the chain. The master communicates sequentially with all devices through the same MOSI and MISO lines. While this approach reduces the number of Chip Select lines needed, it introduces limitations. For example, a failure in one device can disrupt communication with all subsequent devices. In other words, the operation of the system highly depends on chain integrity. Moreover, the master must communicate with all devices in the chain to access a specific one, which can increase latency.

This disclosure addresses the above limitations and challenges by introducing an improved implementation of addressable SPI tailored for high-side devices or intelligent power devices (IPDs). This disclosure not only meets the fast data acquisition requirements but also incorporates a fail-safe mechanism to facilitate uninterrupted communication even in the event of device failure. As an example, this disclosure is suitable for automotive and industrial applications, where performance, scalability, and reliability are helpful.

This disclosure provides an improved addressable SPI that assigns a unique node address to each device. All devices share the same Chip Select line, allowing the master to address each device individually through its unique address. Sucha an architecture offers significant advantages. For example, the improved addressable SPI can support multiple devices without requiring additional IO resources, enhancing scalability. Moreover, the improved addressable SPI can maintain communication even if a single device fails, enhancing functional safety (FuSa). Further, Efficiency: the improved addressable SPI can provide high-speed communication (e.g., up to 10 MHz) with direct access to any device on the bus.

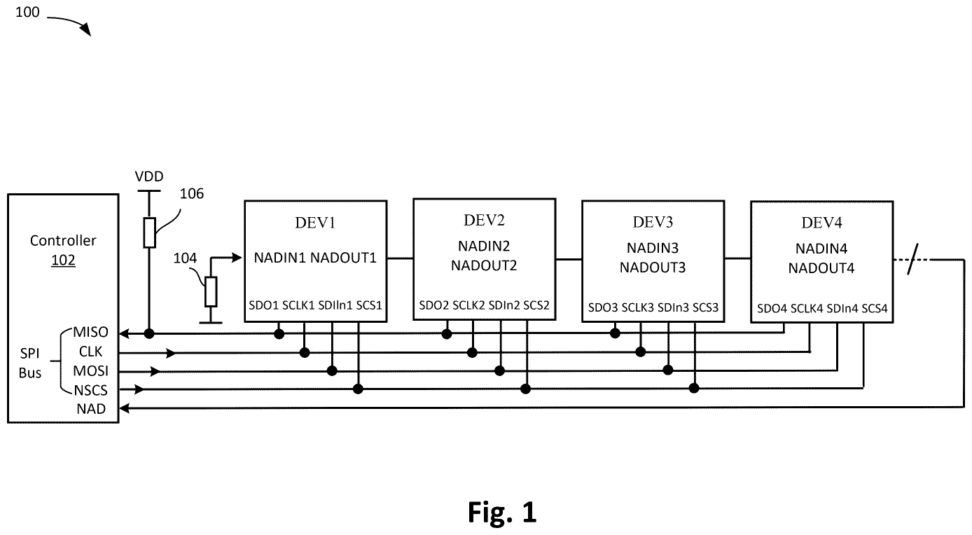

FIG. 1 is a diagram illustrating an example system 100 for implementing an addressable SPI according to an illustrative embodiment. In this example, the system 100 can include a controller 102 which can serve as the master. For instance, the controller 102 can include a microcontroller (μP), central processing unit (CPU), field-programmable gate array (FPGA) or any other circuitry that is configured to control and operate power driver 114. Controller 102 can further include at least one memory devices such as read only memory (ROM), random access memory (RAM), electrically-erasable programmable read only memory (EEPROM), or other types of memory devices. The controller 102 can include an SPI bus.

In this example, the SPI bus can include four signal lines, that is, a Master In Slave Out line MISO, a clock line CLK, a Master Out Slave In line MOSI, and a master chip select line NSCS. The Master In Slave Out line MISO is configured to transmit MISO frames to devices in the system 100. The clock line CLK is configured to transmit an SPI clock signal to the devices in the system 100. The system 100 operates synchronously using the SPI clock signal, ensuring data exchange consistency between the controller 102 and devices. The Master Out Slave In line MOSI is configured to transmit MOSI frames to devices in the system 100. The master chip select line NSCS is configured to transmit a chip select signal to the devices in the system 100. The master chip select line NSCS can control the communication on the SPI bus. When the chip select signal is low, devices are enabled to participate in the data exchange.

The controller 102 can further include a NAD line configured to receive NAD signal from the device. For instance, the system 100 can support up to 32 devices connected via the shared SPI bus.

The system 100 can further include a first device DEV1, a second device DEV2, a third device DEV3, and a fourth device DEV4. Note that though FIG. 1 shows four devices in the system 100, the number of devices is not limited herein, and there can be more or fewer devices. Each device can include a set of signal pins.

For instance, the first device DEV1 can include a first node address input pin NADIN1, a first node address output pin NADOUT1, a first slave device output pin SDO1, a first slave clock pin SCKL1, a first slave device input pin SDIn1, a first slave chip select pin SCS1. The first node address input pin NADIN1 is configured to receive an initial node address signal. The first node address output pin NADOUT1 is configured to output a first node address signal. The first slave device output pin SDO1 is configured to output a first MISO frame to the controller 102. The first slave clock pin SCLK1 is configured to receive the clock signal from the controller 102. The first slave chip select pin SCS2 is configured to receive the chip select signal from the controller 102.

The second device DEV2 can include a second node address input pin NADIN2, a second node address output pin NADOUT2, a second slave device output pin SDO2, a second slave clock pin SCKL2, a second slave device input pin SDIn2, a second slave chip select pin SCS2. The second node address input pin NADIN2 is configured to receive the first node address signal from the first node address output pin NADOUT1 of the first device DEV1. The second node address output pin NADOUT2 is configured to output a second node address signal. The second slave device output pin SDO2 is configured to output a second MISO frame to the controller 102. The second slave clock pin SCLK2 is configured to receive the clock signal from the controller 102. The second slave chip select pin SCS2 is configured to receive the chip select signal from the controller 102.

The third device DEV3 can include a third node address input pin NADIN3, a third node address output pin NADOUT3, a third slave device output pin SDO3, a third slave clock pin SCKL3, a third slave device input pin SDIn3, a third slave chip select pin SCS3. The third node address input pin NADIN3 is configured to receive the second node address signal from the second node address output pin NADOUT2 of the second device DEV2. The third node address output pin NADOUT3 is configured to output a third node address signal. The third slave device output pin SDO3 is configured to output a third MISO frame to the controller 102. The third slave clock pin SCLK3 is configured to receive the clock signal from the controller 102. The third slave chip select pin SCS3 is configured to receive the chip select signal from the controller 102.

The fourth device DEV4 can include a fourth node address input pin NADIN4, a fourth node address output pin NADOUT4, a fourth slave device output pin SDO4, a fourth slave clock pin SCKL4, a fourth slave device input pin SDIn4, a fourth slave chip select pin SCS4. The fourth node address input pin NADIN4 is configured to receive the third node address signal from the third node address output pin NADOUT3 of the second device DEV3. The fourth node address output pin NADOUT4 is configured to output a fourth node address signal. The fourth slave device output pin SDO4 is configured to output a fourth MISO frame to the controller 102. The fourth slave clock pin SCLK4 is configured to receive the clock signal from the controller 102. The fourth slave chip select pin SCS4 is configured to receive the chip select signal from the controller 102.

The first device DEV1 can have its first node address input pin NADIN1 shorted to the ground through a first resistor 104. As an example, the resistive value of the first resistor 104 can be 10K ohm. The value (10K) of the first resistor 104 used for grounding NADIN can be further optimized based on system requirements. Such a configuration establishes the starting address for the devices and ensures that the node address (NAD) initialization sequence begins correctly. The first node address output pin NADOUT1 of the first device DEV1 can be connected to the second node address input pin NADIN2 of the second device DEV2. The second node address output pin NADOUT2 of the second device DEV2 can be connected to the third node address input pin NADIN3 of the third device DEV3. The third node address output pin NADOUT3 of the third device DEV3 can be connected to the fourth node address input pin NADIN4 of the fourth device DEV4. The fourth node address output pin NADOUT4 of the third device DEV4 can be connected to the node address line NAD of the SIP bus.

The first slave device output pin SDO1 of the first device DEV1, the second slave device output pin SDO2 of the second device DEV2, the third slave device output pin SDO3 of the third device DEV3, the fourth slave device output pin SDO4 of the fourth device DEV4 can be connected to the Master In Slave Out line MISO of the SIP bus. The first slave clock pin SCLK1of the first device DEV1, the second slave clock pin SCLK2 of the second device DEV2, the third slave clock pin SCLK3 of the third device DEV3, the fourth slave clock pin SCLK4 of the fourth device DEV4 can be connected to the clock line CLK of the SIP bus. The first slave device input pin SDIn1 of the first device DEV1, the second slave device input pin SDIn2 of the second device DEV2, the third slave device input pin SDIn3 of the third device DEV3, the fourth slave device input pin SDIn4 of the fourth device DEV4 can be connected to the Master Out Slave line MOSI of the SIP bus. The first slave chip select pin SCS1 of the first device DEV1, the second slave chip select pin SCS2 of the second device DEV2, the third slave chip select pin SCS3 of the third device DEV3, the fourth slave chip select pin SCS4 of the fourth device DEV4 can be connected to the master chip select line of the SIP bus.

Moreover, the system 100 can further include a second resistor 106 which is a passive pull-up resistor to VDD implemented on the MISO line at the controller 102 side. This configuration enables open-drain fault indication during the node address registration (NADR) transmission phase, allowing devices to signal addressing or fault issues reliably. Moreover, the pull-up or pull-down (passive/active) configurations on the NADIN and NADOUT lines in the system 100 can be altered. Additionally, the polarity of pulses can be altered to optimize overall system current consumption.

During power-up, the controller 102 uses the NAD line to determine the number of devices connected by counting the pulses received back on NAD. Devices automatically determine their positions in the bus and assign themselves sequential addresses (e.g., DEV1=Node 1, DEV2=Node 2, DEV3=Node 3, DEV4=Node 4, etc.). During the initialization phase, “N” pulses can be generated synchronously with the SPI Clock (SCLK) on the NAD line. N is a positive integer and can represent the number of devices connected to the same SPI bus. These N pulses allow the controller 102 to identify and determine the number of devices connected to the same SPI bus when the chip select signal NSCS is low.

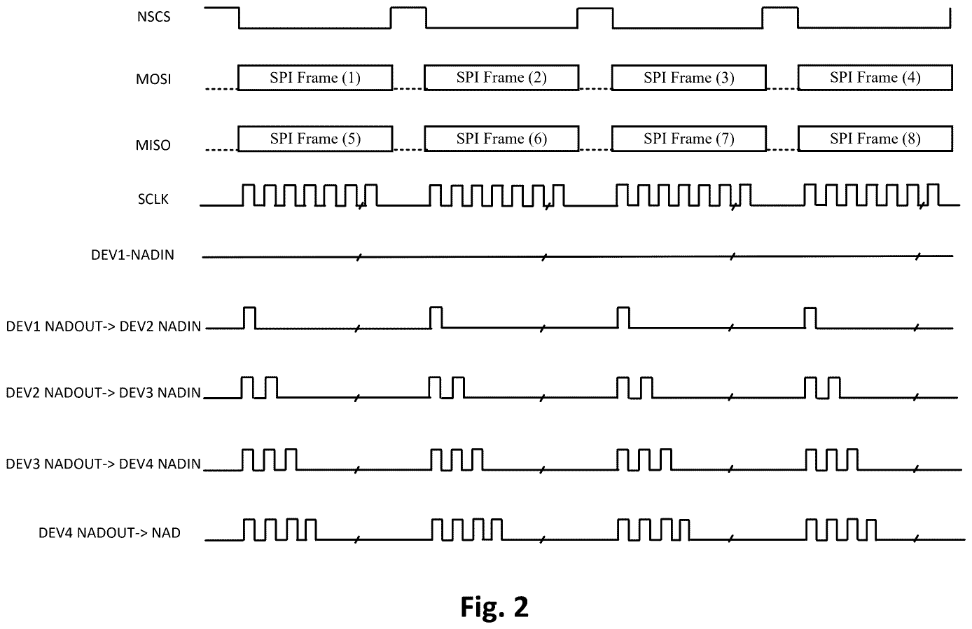

As an example, the communication between the controller 102 and the devices (e.g., DEV1, DEV2, DEV3, and DEV4) can be performed using a 32-bit SPI frame. Within this 32-bit SPI frame, the NADR[4:0] field allows for addressing each device individually with node addresses ranging from 0 to N−1 (where Nmax=32). The SPI frame contains specific node addresses (N Address) and register addresses (S Address), enabling the processor to communicate with individual devices efficiently. Standardized 32-bit frames can be used to uniform communication without the need for software customization, even as devices are added or removed. Additional details off the SPI frame are provided with respect to FIG. 2.

Communication occurs on the Master Out Slave In line MOSI and the Master In Slave Out line MISO of the SPI bus. The controller 102 can transmit data and addresses to devices (e.g., DEV1, DEV2, DEV3, and DEV4) via the Master Out Slave In line MOSI. Master In Slave Out line MISO allows devices (e.g., DEV1, DEV2, DEV3, and DEV4) to send back status, data, or fault indicators to the controller 102.

In operation, the controller 102 initializes communication with the devices (e.g., DEV1, DEV2, DEV3, and DEV4) over the SPI bus while monitoring the NAD line for pulse feedback. Devices (e.g., DEV1, DEV2, DEV3, and DEV4) register themselves unique addresses via the NADIN/NADOUT mechanism. The NADINx (xth Node Address Input) pin and the NADOUTx (xth Node Address Output) pin allow automatic node address assignment, where x is the serial number of device. For instance, DEV1 initializes as the first device because NADIN1 detects the ground condition (no pulses). The first device DEV1 generates one pulse on NADOUT1, which propagates to NADIN2 of DEV2. DEV2, in turn, increments the pulse count and forwards it via NADOUT2 to DEV3. DEV3, in turn, increments the pulse count and forwards it via NADOUT33 to DEV4. This process continues sequentially for all devices on the SPI bus. Through this mechanism, each device assigns itself a unique node address based on the pulse count observed on its NADIN pin. Though in this example, there are four devices, there can be more or fewer devices on the SPI bus.

During data transmission, the controller 102 can send commands directly to specific devices using their assigned node addresses and can access their registers through the node address. Devices (e.g., DEV1, DEV2, DEV3, and DEV4) respond back with their data while ensuring data integrity using a CRC mechanism. the first device DEV1 starts the address assignment process. Each subsequent device increments its node address (NAD) via the NADOUT line, propagating the addressing down the chain. Devices are addressed individually using their unique node address registration NADR value, facilitating communication between the controller 102 and the devices. As an example, the system 100 can support up to 32 devices on the same SPI bus.

Additionally, a global error reporting allows any device to communicate faults without being individually addressed. This architecture ensures reliable, high-speed communication with efficient addressing, scalability, and fault tolerance across the SPI network.

FIG. 2 illustrates timing diagrams showing the operation of the system 100 for implementing an addressable SPI according to an illustrative embodiment. In this example, FIG. 2 shows the sequential addressing process across devices (DEV1 through DEV4) and SPI communication between a controller 102 (master) and multiple devices (slaves) (e.g., DEV1,DEV2, DEV3, and DEV4).

The master chip select line NSCS controls when SPI communication occurs. When NSCS is low, the SPI communication is active, enabling devices (e.g., DEV1, DEV2, DEV3, and DEV4) to exchange data with the master i.e., the controller 102. Each period where NSCS goes low corresponds to one 32-bit SPI frame being transmitted.

The Master Output Slave In line MOSI carries data sent by the controller 102 to the connected devices (e.g., DEV1, DEV2, DEV3, and DEV4). Data is transmitted in the SPI frames labeled as SPI frame (1), SPI frame (2), SPI frame (3), and SPI frame (4) respectively. In this example, each SPI frame can be a 32-bit frame that contains information, including a node address register NADR, allowing the controller 102 to address and communicate with a respective device.

The Master In Slave Out line MISO carries data sent back from the devices (e.g., DEV1, DEV2, DEV3, and DEV4) to the controller 102. The response from devices is also in the form of SPI frames, labeled as SPI frame (5), SPI frame (6), SPI frame (7), and SPI frame (8). In this example, each SPI frame can be a 32-bit frame. This allows the master to receive data or acknowledgments from addressed devices (e.g., DEV1, DEV2, DEV3, and DEV4).

The clock line SCLK provides the clock signal for synchronizing data transfers on MOSI and MISO lines. As an example, each 32-bit SPI frame can correspond to 32 clock pulses on the SCLK line. The clock pulses are continuous when chip select signal NSCS is low, enabling SPI communication.

FIG. 2 also shows the timing of the node address assignment process using NADIN/NADOUT pins. For instance, DEV1-NADIN shows that the first device DEV1 initializes its address since the first node address input pin NADIN1 is grounded (no prior pulses detected). The first device DEV1 generates one pulse on the first node address input pin NADIN1, indicating its position as the first device in the chain.

DEV1 NADOUT→DEV2 NADIN shows the first node address signal that the first device DEV1 transmits from the first node address output pin NADOUT1 to the second node address input pin NADIN2 of the second device DEV2. The first node address signal includes one pulse.

DEV2 NADOUT→DEV3 NADIN shows the second node address signal that the second device DEV2 transmits from the second node address output pin NADOUT2 to the third node address input pin NADIN3 of the third device DEV3. After receiving the first node address signal from the first device DEV1 which includes one pulse, the second device DEV2 increments the pulse count and generates two pulses on its NADOUT2 pin, forwarding them to the next device DEV3.

DEV3 NADOUT→DEV4 NADIN shows the third node address signal that the third device DEV3 transmits from the third node address output pin NADOUT3 to the fourth node address input pin NADIN4 of the fourth device DEV4. The third device DEV3 receives the two pulses on its NADIN3 pin, increments the pulse count to three pulses, and propagates it further to the fourth device DEV4.

DEV4 NADOUT→NAD shows the third node address signal that the fourth device DEV4 transmits from the fourth node address output pin NADOUT4 to the node address line NAD of the SPI bus of the controller 102. The fourth device DEV4 receives the three pulses from the third device DEV3, increments the count to four pulses, and sends it out via its NADOUT pin, and the pulse count is forwarded back to the controller 102 through the node address line NAD. The controller 102 uses this information to determine the total number of connected devices (4 in this case).

When the system 100 is powered on, each device can determine its own address based on the pulses it receives and sends back. Each device can register its address based on the pulse it receives. For an example, the first device DEV1 receives zero pules and sends one pulse, and determines that it is the first device in the chain. This self-addressing happens at the initialization stage. In this example, devices can automatically assign their addresses sequentially using the NADIN and NADOUT pins. Each device increments the pulse count and forwards it to the next device in the chain. The final pulse count on the NAD line informs the processor of the total device count. This architecture ensures scalability and reliability in multi-device SPI systems.

The controller 102 can issue a global broadcast command (e.g., register NADR) for all devices to register their addresses. In addition, reserved addresses (e.g., 7E) are for global commands. Global commands are processed by all devices, but only the intended device responds when necessary. Once addresses are registered, communication shifts to specific addressing, where only the addressed device responds. As an example, for a specific command, e.g., turn on output of the third device DEV3, only the third device DEV3 processes and executes it.

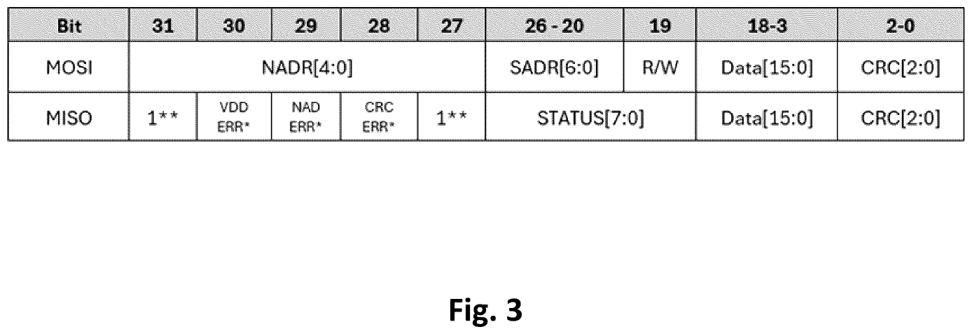

FIG. 3 is a diagram showing example frames that implement addressable SPI according to an illustrative embodiment. For example, the frames shown in FIG. 3 can be used in communication between a master such as the controller 102 and slave devices such as the first device DEV1, the second device DEV2, the third device DEV3, and the fourth device DEV4. As an example, the structure of the example frames can represent a 32-bit SPI standard with specific bit assignments for both MOSI and MISO data.

For example, in a MOSI frame (Master to Device), Bit 31 is reserved as a constant 1. In the corresponding MISO frame (Device to Master), Bit 31 is asserted high by the device assigned to NAD=0. This ensures that the device assists the external pull-up resistor in maintaining high-speed timing and signal integrity during communication. Bits 30-27 (NADR[4:0]) represents the node address of the target device (values range from 0x00 to 0x31), uniquely identifying each device on the SPI bus. Slave Address bits 26-20 (SADR[6:0]) can be reserved exclusive for broadcast commands. The range is 0x00 to 0x7F, with certain addresses reserved for broadcast commands. Bit 19 (R/W) specifies the read/write operation. For instance, 0x0 can represent write operation, and 0x1 can represent read operation. Bits 18-3 (Data[15:0]) contains 16-bit data payload sent to the target device. Bits 2-0 (CRC[2: 0]) represents a 3-bit CRC (Cyclic Redundancy Check) calculated for bits 31 through 3 to ensure data integrity.

As another example, in a MISO frame (Device to Master), Bits 31 is reserved as constant 1, similar to the MOSI frame. Bit 30 (VDD ERR) represents a supply voltage error flag indicating a VDD under-voltage condition. Bit 29 (NAD ERR) represents an error flag for Node Address Detection (NAD) error, signaling a mismatch or addressing fault. Bits 28 (CRC ERR) represents an error flag for CRC frame errors during the MOSI transmission. Bit 27 is reserved as 1 for alignment and consistency. Bits 26-19 (STATUS[7:0]) represents a status summary byte containing diagnostic and operational information about the device. Bits 18-3 (Data[15:0]): Represents the 16-bit data response from the device to the master. Bits 2-0 (CRC[2:0]) represents a 3-bit CRC for bits 31 through 3 of the MISO frame, ensuring data integrity. As an example, the communication speed can be approximately 3.2 microseconds per frame, ensuring minimal delay even with multiple devices.

The system 100 can implement error detection techniques and debugging mechanisms to identify communication conflicts, device malfunctions, and operational errors efficiently. Upon power-up or a power cycle, the system 100 can perform an automatic self-check to verify the expected number of connected devices. For instance, the programmer or software knows the number of devices physically populated on the printed circuit board (PCB), as the system design is predetermined. For example, a maximum of 32 devices can be supported due to the 5-bit address space (2⁵=32).

As an example, the system 100 can detect initialization errors during the initialization stage. For example, the controller 102 can verify communication with each device. If the controller 102 expects seven devices but receives the acknowledgment from only five devices, the controller 102 can flag an initialization error. This discrepancy indicates either a hardware connection problem or device failure.

Moreover, the system 100 can identify errors in node addressing and communication conflicts. During the first five bits of an SPI frame, no specific device address is active. These first five bits of the SPI frame are used to indicate potential problems. If a device encounters an issue (e.g., a hardware fault), it transmits a zero during this period. Specifically, the device drives the bus low by turning on an NMOS transistor, effectively pulling the signal rail to ground. The SPI system employs an open-drain implementation to prevent multiple devices from driving the bus simultaneously in opposite directions (one sending a ‘1’ while another sends a ‘0’). Such conflicts could cause a short circuit between VDD and ground, potentially resetting the power supply. To avoid this, the system 100 ensures that pull-up signals (transmitting a ‘1’) are current-limited, whereas pull-down signals (transmitting a ‘0’) are strong. When a current-limited signal is overridden, the system 100 detects a conflict.

If a conflict occurs (e.g., two devices attempt simultaneous communication), the device detecting the conflict stops transmitting immediately. The controller 102 is notified of the error in the subsequent frame via a Node Address Error bit. Even if the controller is communicating with another device, any problematic device can still signal an error.

Additionally, the system 100 can generate the following error detection signals. VDD Error bit VDD ERR can indicate a power supply issue or a break in the communication path between the controller and a device. Node Address Error bit NAD ERR can be detected as described above during the open-drain implementation of the first five bits. Cyclic Redundancy Check (CRC) Error bit CRC ERR can ensure data integrity. If the payload transmitted does not match the CRC calculation, a CRC error is flagged. The VDD ERR, NAD ERR, and CRC ERR bits are generated based on information from the previous frame and are automatically cleared once transmitted. While both VDD ERR and NAD ERR can be reported by any device on the bus, the CRC ERR is exclusively indicated by the device that was addressed in the prior frame. Any of these errors—VDD ERR, NAD ERR, and CRC ERR—can alert the processor that the SPI chain may not be functioning correctly.

The system 100 may perform debugging and error reporting operations. For instance, when an error is detected, the controller 102 can inform the user or higher-level software of a problem to fix it. Moreover, the system 100 may include dedicated debug registers Node Address Debug Registers NADRs to assist in diagnosing hardware issues. These Node Address Debug Registers NADRs can log error information, providing insight into the root cause for further debugging.

Moreover, such an error detection mechanism can help safe state operation of the system 100. If errors occur during power initialization (e.g., a break between devices), the system 100 can detect the issue early and prevent unsafe operation. For example, in automotive applications, errors are flagged before the car becomes operational, ensuring that faults do not occur during driving.

In implementation, if a device encounters an issue, it can transmit an error signal without waiting for a direct communication request from the controller. This ensures real-time reporting of faults. For example, A problematic device sets an error bit during the next frame. Even if the controller 102 is communicating with another device, the error bit can notify the controller 102 of the fault via s MISO frame as described above.

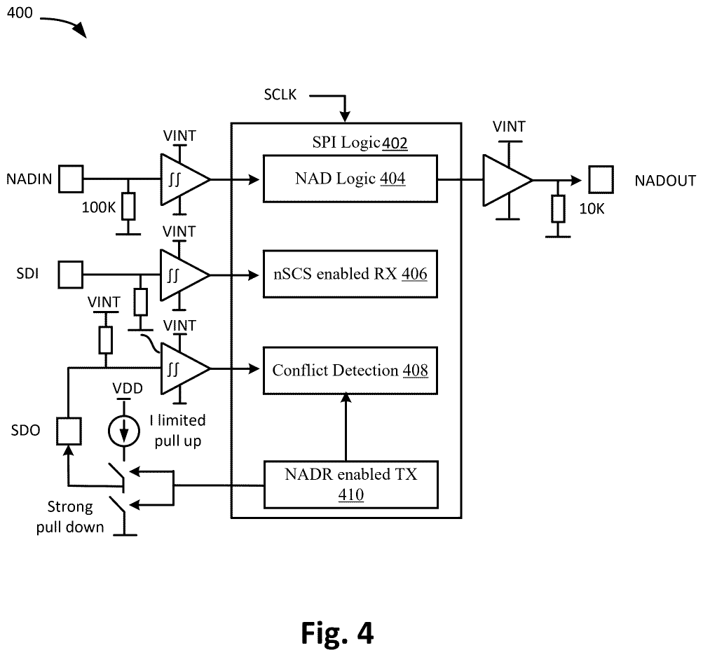

FIG. 4 is a diagram illustrating an example device 400 for implementing an addressable SPI system according to an illustrative embodiment. For instance, the device 400 can be used as any of the first device DEV1, the second device DEV2, the third device DEV3, and the fourth device DEV4 shown in FIG. 1. Referring to FIG. 4, device 400 can include a node address input pin NADIN, a slave device input pin SDIn, a slave device output pin SDO, a slave clock pin SCLK, and a node address output pin NADOUT, and a SPI logic component 402.

The node address input pin NADIN is configured to receive a node address signal from a previous device in the chain or be shortened to the ground. The node address output pin NADOUT is configured to output a node address signal to a next device in the chain. The slave device output pin SDO is configured to output a MISO frame to a master such as the controller 102. The slave clock pin SCLK is configured to receive the clock signal from the master such as the controller 102. The slave chip select pin SCS2 is configured to receive the chip select signal from the master such as the controller 102.

SPI logic component 402 can include a node address (NAD) logic component 404, a chip select (NSCS) enabled receiver (RX) component 406, a conflict detection component 408, a node address register (NADR) enabled transmitter (TX) component 410.

The node address (NAD) logic component 404 is configured to receive and process incoming signals from the NADIN pin. The node address (NAD) logic component 404 can register a unique node address for the device 400 using pulses received on the NADIN pin. For instance, during a broadcast command (e.g., “REGISTER NAD ADDRESS”) from the controller 102, the node address (NAD) logic component 404 counts the number of consecutive pulses on the NADIN pin while the Chip Select (CS) signal is low and synchronized to the clock signal SCLK. This count represents the node address (NAD) assigned to the device

Moreover, the NAD logic component 404 can drive the node address output pin NADOUT, which can transmit pulses corresponding to the count received on NADIN plus one.

The NSCS enabled RX component 406 is configured to receive and process incoming signals from the SDIn pin when the chip select signal (NSCS) is active (low). As an example, the NSCS enabled RX component 406 operates only when the NSCS signal is asserted (e.g., logic low), which indicates that the device 400 is selected and is expected to communicate with the master such as the controller 102.

The conflict detection component 408 is configured to receive and process incoming signals from the SDO pin. The conflict detection component 408 can identify and handle communication conflicts that may occur on the SPI bus, particularly when multiple devices attempt to drive the same line. The conflict detection component 408 can work in conjunction with other components to ensure reliable communication between the controller 102 and the devices within the SPI system.

The NADR enabled TX component 410 is configured to transmit data from the device to the SPI bus via the SDO pin. For instance, after confirming the NAD address of the device, the NADR enabled TX component 410 can send out a MISO frame via the MISO line.

The MISO buffer includes a strong pull-down capability and a current-limited (~30 mA) pull-up feature to prevent excessive current during potential bus conflicts. If a conflict occurs—such as multiple devices trying to drive MISO simultaneously—the device detects the issue as a NAD error and ceases transmission for the frame..

The device 400 can signal a NAD error under several conditions. For example, The device 400 can signal a run-time errors during SPI frames, including a mismatch between the registered NAD address and the pulses counted on NADIN, inconsistent or stuck-high pulses on NADIN, and the detection of current limitation during MISO transmission indicating a bus conflict.

Moreover, the device 400 can perform power-up checks, where the device verifies the impedance on the NADIN pin to ground (target: 10 kΩ±30%). This ensures the integrity of the NADIN connection.

The configuration of the device 400 can support improved node address-based communication, error signaling, and conflict prevention, making it suitable for multi-device SPI systems with dynamic addressing requirements.

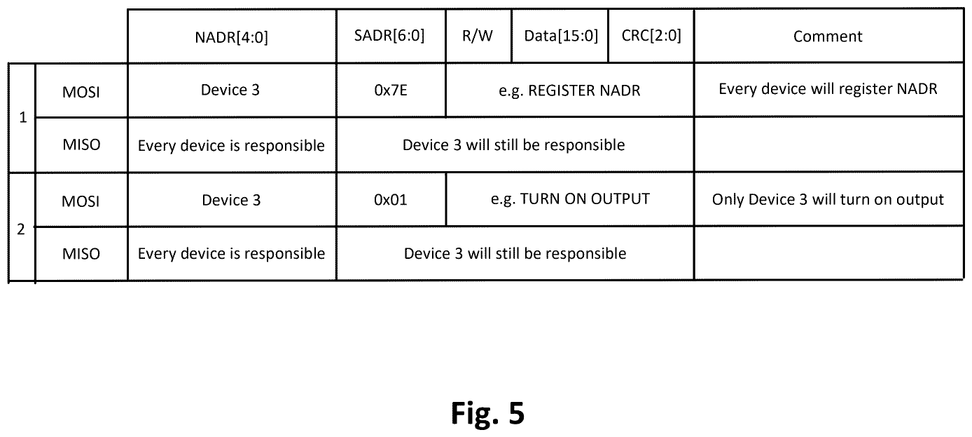

FIG. 5 is a diagram showing example frames that implement addressable SPI according to an illustrative embodiment. For example, the frames shown in FIG. 5 can be used in communication between a master such as the controller 102 and slave devices such as the first device DEV1, the second device DEV2, the third device DEV3, and the fourth device DEV4. As an example, the structure of the example frames can represent a 32-bit SPI standard with specific bit assignments for both MOSI and MISO data.

In a first example, a MOSI frame can include the following fields. NADR[4:0] field can represent the node address of the target device (values range from 0x00 to 0x31). In this example, NADR[4:0] field uniquely identifies Device 3 as the target device. SADR[6:0] field can be reserved exclusively for broadcast commands. As an example, the value is 0x7E, which means a global broadcast command is enabled. R/W field, Data[15:0] field, and CRC[2:0] field can be used to represent the global broadcast command e.g., “REGISTER NADR” instructing each device to register their node addresses.

In this first example, a corresponding MISO frame can include the following fields. NADR[4:0] field can represent the node address of a specific device, and every device is responsible for this field. SADR[6:0] field, R/W field, Data[15:0] field, and CRC[2:0] field can represent information provided by Device 3 in response to the device-specific command to Device 3. Only device 3 is responsible for these fields.

In a second example, a MOSI frame can include the following fields. NADR[4:0] field can represent the node address of the target device (values range from 0x00 to 0x31). In this example, NADR[4:0] field uniquely identifies Device 3 as the target device. SADR[6:0] field can be reserved exclusively for broadcast commands. As an example, the value is 0x01, which means a global broadcast command is not enabled. R/W field, Data[15:0] field, and CRC[2:0] field can be used to represent the device-specific command e.g., “TURN ON OUTPUT” instructing Device 3 to turn on its output.

In this first example, a corresponding MISO frame can include the following fields. NADR[4:0] field can represent the node address of a specific device, and every device is responsible for this field. SADR[6:0] field, R/W field, Data[15:0] field, and CRC[2:0] field can represent information provided by Device 3 in response to the device-specific command to Device 3. Only Device 3 is responsible for these fields.

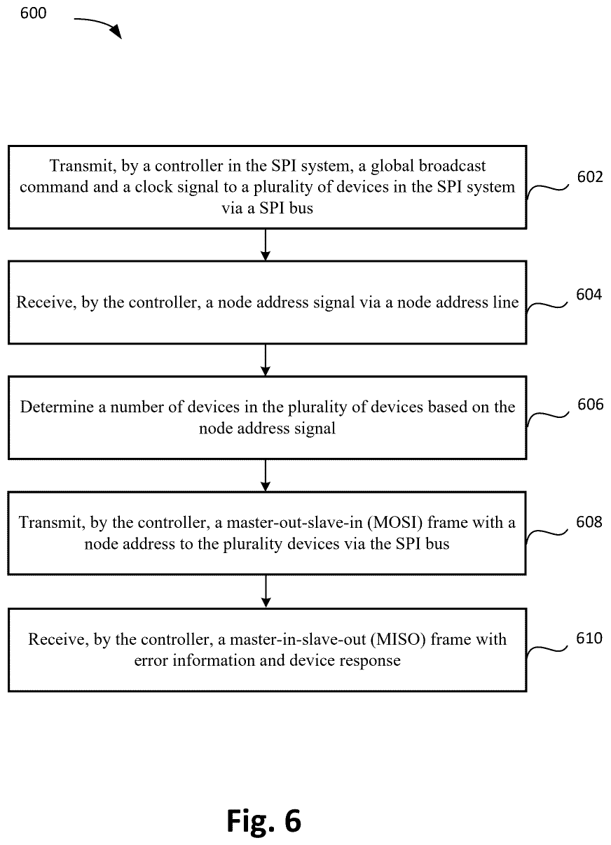

FIG. 6 illustrate a process 600 for managing an addressable serial peripheral interface (SPI) system according to an illustrative embodiment. The process 600 described here can be performed by the example system 100 shown in FIG. 1. Process 600 can include one or more operations, actions, or functions as illustrated by one or more of blocks 602-410. Although illustrated as discrete blocks, various blocks may be divided into additional blocks, combined into fewer blocks, eliminated, performed in different order, or performed in parallel, depending on the desired implementation.

Referring to FIG. 6, process 600 can begin at block 602. At block 602, a controller 102 in the system 100 can transmit, a global broadcast command and a clock signal to a plurality of devices in the system via a SPI bus.

Process 600 can proceed from block 602 to block 604. At block 604, the controller 102 can a node address signal via a node address line.

Process 600 can proceed from block 604 to block 606. At block 606, the controller 102 can determine a number of devices in the plurality of devices based on the node address signal.

Process 600 can proceed from block 606 to block 608. At block 608, the controller 102 can transmit a MOSI frame with a node address to the plurality of devices via the SPI bus.

Process 600 can proceed from block 608 to block 610. At block 608, the controller 102 can receive a MISO frame with error information and device response.

### EXAMPLES

Clause 1. A system for implementing addressable serial peripheral interface (SPI) comprising: a controller comprising a SPI bus and a node address (NAD) line, the controller being configured to transmit a chip select signal and a clock signal via the SPI bus, and receive a respective node address signal via the NAD line; and a plurality of devices connected in a chain, the plurality of devices being connected to the SPI bus of the controller, a respective device of the plurality of devices being configured to: receive the chip select signal and the clock signal from the controller via the SPI bus; determine a respective node address associated with the respective device based on the chip select signal and the clock signal; generate a respective node address signal indicating the respective node address; and transmit the respective node address signal to an adjacent device in the chain or the NAD line.

Clause 2. The system of Clause 1, wherein the SPI bus comprises: a master in slave out (MISO) line configured to transmit a MISO signal; a clock line configured transmit the clock signal; a master out slave in (MOSI) line configured to transmit a MOSI signal; and a master chip select line configured to transmit the chip select signal.

Clause 3. The system of Clause 1-2, wherein the respective device comprises: a respective slave device output pin connected to the MISO line of the SPI bus, the respective slave device output pin being configured to receive the MISO signal from the MISO line; a respective slave clock pin connected to the clock line of the SPI bus, the respective slave clock pin being configured to receive the clock signal from the clock line; a respective slave device input pin connected to the MISO line of the SPI bus, the respective slave device input pin being configured to receive the MISO signal from the MISO line; and a respective slave chip select pin connected to the master chip select line, the respective slave chip select pin being configured to receive the chip select signal from the master chip select line.

Clause 4. The system of Clause 1-3, wherein the respective device further comprises: a respective node address input pin configured to receive a node address signal from ground or another device in the plurality of devices; and a respective node address output pin configured to output the respective node address signal.

Clause 5. The system of Clause 1-4, wherein the respective device is further configured to transmit a MISO frame to the controller via the MISO line.

Clause 6. The system of Clause 1-5, wherein the MISO frame comprises a node address error bit indicating present of a node address error.

Clause 7. The system of Clause 1-6, wherein the controller is further configured to transmit a MOSI frame to the respective device via the MOSI line.

Clause 8. The system of Clause 1-7, wherein the MOSI frame comprises a node address register field indicating the respective node address of the respective device.

Clause 9. The system of Clause 1-8, wherein the MOSI frame comprises a slave register bit indicating whether a global broadcast command is enabled.

Clause 10. An integrated circuit for implementing addressable serial peripheral interface (SPI) comprising: a plurality of devices connected in a chain, the plurality of devices being connected to a SPI bus of a controller, a respective device of the plurality of devices being configured to: receive a chip select signal and a clock signal from the controller via the SPI bus; determine a respective node address associated with the respective device based on the chip select signal and the clock signal; generate a respective node address signal indicating the respective node address; and transmit the respective node address signal to one of an adjacent device in the chain and a node address (NAD) line of the controller.

Clause 11. The integrated circuit of Clause 10, wherein the SPI bus comprises: a master in slave out (MISO) line configured to transmit a MISO signal; a clock line configured transmit the clock signal; a master out slave in (MOSI) line configured to transmit a MOSI signal; and a master chip select line configured to transmit the chip select signal.

Clause 12. The integrated circuit of Clause 10-11, wherein the plurality of devices comprises m devices, m being an integer number, an n-th device of the plurality of devices comprising: an n-th slave device output pin connected to the MISO line of the SPI bus, the n-th slave device output pin being configured to receive the MISO signal from the MISO line; an n-th slave clock pin connected to the clock line of the SPI bus, the n-th slave clock pin being configured to receive the clock signal from the clock line; an n-th slave device input pin connected to the MISO line of the SPI bus, the n-th slave device input pin being configured to receive the MISO signal from the MISO line; and an n-th slave chip select pin connected to the master chip select line, the n-th slave chip select pin being configured to receive the chip select signal from the master chip select line wherein n is a positive integer being smaller than or equal to m.

Clause 13. The integrated circuit of Clause 10-12, wherein the n-th device further comprises: an n-th node address input pin connected to ground or an (n−1)th device in the plurality of devices, the n-th node address input pin being configured to receive an (n−1)th node address signal from the (n−1)th device; and an n-th node address output pin connected to an (n+1)th node address input pin of an (n+1)th device, the n-th node address output pin being configured to output an n-th node address signal to an (n+1)th device in the plurality of devices or to the NAD line of the controller.

Clause 14. The integrated circuit of Clause 10-13, wherein: the (n−1)th node address signal comprises (n−1) pulses; the n-th node address signal comprises n pulses; and the (n+1)th node address signal comprises (n+1) pulses.

Clause 15. The integrated circuit of Clause 10-14, wherein the n-th device is further configured to transmit a MISO frame to the controller via the MISO line.

Clause 16. The integrated circuit of Clause 10-15, wherein the MISO frame comprises: a node address error bit indicating presence of a node address error; a supply voltage error bit indicating an under-voltage condition of a supply voltage; and a cyclic redundancy check (CRC) error bit indicating presence of a CRC error.

Clause 17. The integrated circuit of Clause 10-16, wherein the controller is further configured to transmit a MOSI frame to the respective device via the MOSI line.

Clause 18. The integrated circuit of Clause 10-17, wherein the MOSI frame comprises a node address register field indicating the n-th node address of the respective device.

Clause 19. A method for managing an addressable serial peripheral interface (SPI) system comprising: transmitting, by a controller in the SPI system, a global broadcast command and a clock signal to a plurality of devices in the SPI system via a SPI bus; receiving, by the controller, a node address signal via a node address line; and determining, by the controller, a number of devices in the plurality of devices based on the node address signal.

Clause 20. The method of Clause 19 further comprising: transmitting, by the controller, a master-out-slave-in (MOSI) frame with a node address to the plurality of devices via the SPI bus; and receiving, by the controller, a master-in-slave-out (MISO) frame with error information and device response.

The flowchart and block diagrams in the Figures illustrate the architecture, functionality, and operation of possible implementations of systems, methods, and computer program products according to various embodiments of the present disclosure. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be implemented substantially concurrently, or the blocks may sometimes be implemented in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The terminology used herein is for the purpose of describing particular embodiments only and is not intended to be limiting to the present disclosure. As used herein, the singular forms “a”, “an” and “the” are intended to include the plural forms as well, unless the context indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements, if any, in the claims below are intended to include any structure, material, or act for performing the function in combination with other claimed elements as specifically claimed. The disclosed embodiments of the present disclosure have been presented for purposes of illustration and description but are not intended to be exhaustive or limited to the embodiments in the forms disclosed. Many modifications and variations will be apparent to those of ordinary skill in the art without departing from the scope and spirit of the present disclosure. The embodiments were chosen and described in order to best explain the principles of the present disclosure and the practical application, and to enable others of ordinary skill in the art to understand the present disclosure for various embodiments with various modifications as are suited to the particular use contemplated.

What is claimed is:

1. A system for implementing addressable serial peripheral interface (SPI) comprising:
a controller comprising a SPI bus and a node address (NAD) line, the controller being configured to transmit a chip select signal and a clock signal via the SPI bus, and receive a respective node address signal via the NAD line; and
a plurality of devices connected in a chain, the plurality of devices being connected to the SPI bus of the controller, a respective device of the plurality of devices being configured to:
receive the chip select signal and the clock signal from the controller via the SPI bus;
determine a respective node address associated with the respective device based on the chip select signal and the clock signal;
generate a respective node address signal indicating the respective node address; and
transmit the respective node address signal to an adjacent device in the chain or the NAD line.

2. The system of claim 1, wherein the SPI bus comprises:
a master in slave out (MISO) line configured to transmit a MISO signal;
a clock line configured transmit the clock signal;
a master out slave in (MOSI) line configured to transmit a MOSI signal; and
a master chip select line configured to transmit the chip select signal.

3. The system of claim 2, wherein the respective device comprises:
a respective slave device output pin connected to the MISO line of the SPI bus, the respective slave device output pin being configured to receive the MISO signal from the MISO line;
a respective slave clock pin connected to the clock line of the SPI bus, the respective slave clock pin being configured to receive the clock signal from the clock line;
a respective slave device input pin connected to the MISO line of the SPI bus, the respective slave device input pin being configured to receive the MISO signal from the MISO line; and
a respective slave chip select pin connected to the master chip select line, the respective slave chip select pin being configured to receive the chip select signal from the master chip select line.

4. The system of claim 3, wherein the respective device further comprises:
a respective node address input pin configured to receive a node address signal from ground or another device in the plurality of devices; and
a respective node address output pin configured to output the respective node address signal.

5. The system of claim 3, wherein the respective device is further configured to transmit a MISO frame to the controller via the MISO line.

6. The system of claim 5, wherein the MISO frame comprises a node address error bit indicating present of a node address error.

7. The system of claim 3, wherein the controller is further configured to transmit a MOSI frame to the respective device via the MOSI line.

8. The system of claim 7, wherein the MOSI frame comprises a node address register field indicating the respective node address of the respective device.

9. The system of claim 7, wherein the MOSI frame comprises a slave register bit indicating whether a global broadcast command is enabled.

10. An integrated circuit for implementing addressable serial peripheral interface (SPI) comprising:
a plurality of devices connected in a chain, the plurality of devices being connected to a SPI bus of a controller, a respective device of the plurality of devices being configured to:
receive a chip select signal and a clock signal from the controller via the SPI bus;
determine a respective node address associated with the respective device based on the chip select signal and the clock signal;
generate a respective node address signal indicating the respective node address; and
transmit the respective node address signal to one of an adjacent device in the chain and a node address (NAD) line of the controller.

11. The integrated circuit of claim 10, wherein the SPI bus comprises:
a master in slave out (MISO) line configured to transmit a MISO signal;
a clock line configured transmit the clock signal;
a master out slave in (MOSI) line configured to transmit a MOSI signal; and
a master chip select line configured to transmit the chip select signal.

12. The integrated circuit of claim 11, wherein the plurality of devices comprises m devices, m being an integer number, an n-th device of the plurality of devices comprising:
an n-th slave device output pin connected to the MISO line of the SPI bus, the n-th slave device output pin being configured to receive the MISO signal from the MISO line;
an n-th slave clock pin connected to the clock line of the SPI bus, the n-th slave clock pin being configured to receive the clock signal from the clock line;
an n-th slave device input pin connected to the MISO line of the SPI bus, the n-th slave device input pin being configured to receive the MISO signal from the MISO line; and
an n-th slave chip select pin connected to the master chip select line, the n-th slave chip select pin being configured to receive the chip select signal from the master chip select line
wherein n is a positive integer being smaller than or equal to m.

13. The integrated circuit of claim 12, wherein the n-th device further comprises:
an n-th node address input pin connected to ground or an (n−1)th device in the plurality of devices, the n-th node address input pin being configured to receive an (n−1)th node address signal from the (n−1)th device; and
an n-th node address output pin connected to an (n+1)th node address input pin of an (n+1)th device, the n-th node address output pin being configured to output an n-th node address signal to an (n+1)th device in the plurality of devices or to the NAD line of the controller.

14. The integrated circuit of claim 13, wherein:
the (n−1)th node address signal comprises (n−1) pulses;
the n-th node address signal comprises n pulses; and
the (n+1)th node address signal comprises (n+1) pulses.

15. The integrated circuit of claim 13, wherein the n-th device is further configured to transmit a MISO frame to the controller via the MISO line.

16. The integrated circuit of claim 15, wherein the MISO frame comprises:
a node address error bit indicating presence of a node address error;
a supply voltage error bit indicating an under-voltage condition of a supply voltage; and
a cyclic redundancy check (CRC) error bit indicating presence of a CRC error.

17. The integrated circuit of claim 13, wherein the controller is further configured to transmit a MOSI frame to the respective device via the MOSI line.

18. The integrated circuit of claim 17, wherein the MOSI frame comprises a node address register field indicating the n-th node address of the respective device.

19. A method for managing an addressable serial peripheral interface (SPI) system comprising:
transmitting, by a controller in the SPI system, a global broadcast command and a clock signal to a plurality of devices in the SPI system via a SPI bus;
receiving, by the controller, a node address signal via a node address line; and
determining, by the controller, a number of devices in the plurality of devices based on the node address signal.

20. The method of claim 19 further comprising:
transmitting, by the controller, a master-out-slave-in (MOSI) frame with a node address to the plurality of devices via the SPI bus; and
receiving, by the controller, a master-in-slave-out (MISO) frame with error information and device response.
